(19) United States
(12) Patent Application Publication
(10) Pub. No.: US 2003/0008661 A1
(43) Pub. Date: Jan. 9, 2003

(54) Location-based content delivery

(76) Inventors: Dennis P. Joyce, Rochester, NY (US); Michael J. Sutter, Piffard, NY (US); Edward T. Woodfield, Rochester, NY (US)

Correspondence Address: WITHROW & TERRANOVA, P.L.L.C., P.O. BOX 1287, CARY, NC, 27512, US

(21) Appl. No.: 09/898,357

(22) Filed: Jul. 3, 2001

(51) Int. Cl. H04Q 7/20

(52) U.S. Cl. 455/456; 455/414; 455/566

(57) ABSTRACT

The present invention facilitates content delivery to a mobile terminal based on the proximity of the mobile terminal to a point of presence associated with a content provider. An application service may identify the location of the mobile terminal and use a locality database or service to determine localities containing the identified location. Based on the localities corresponding to the mobile terminal's location, content is selected and delivered to the mobile terminal. The localities may define any geographic region or area associated with a point of presence. For example, a locality may define a business district for a city, the city, or a defined area about a point of presence. For the latter, a locality could be defined to include an area having a certain radius about a retailer's point of presence or within a certain number of city blocks.

### FIELD OF THE INVENTION

The present invention relates to delivering content to a mobile terminal, and in particular, to delivering content based on a relative location between the mobile terminal and a location for the content provider.

### BACKGROUND OF THE INVENTION

Mobile terminals, such as mobile telephones and wireless personal digital assistants (PDAs), are now capable of receiving content from various types of network devices and presenting the content to users in a visual or audible format. Users of these devices may browse the Internet and receive various types of content. Further, mobile terminals may cooperate with various network services to receive notifications relating to any type of event or information.

Advertisers and other entities are trying to take advantage of this communication medium by sending users content via their mobile terminals. Users are interested in obtaining this information, but are primarily interested in obtaining information that is deemed beneficial. Similarly, content providers, such as advertisers, want to target users most likely to respond to content delivery.

Existing systems using location-based advertising typically break an area into geographic sectors and send notifications when a mobile terminal is within the sector regardless of proximity to a particular point of presence for a content provider. FIG. 1 illustrates a typical configuration wherein A1, A2, and A3 are points of presence for advertisers and West1, West2, East1, and East2 are predefined sectors. Mobile terminal users in one sector will only receive advertisements from an advertiser in the same sector, regardless of the actual proximity between the mobile terminal 16 and the points of presence.

In many cases, the mobile terminal 16 may be in one sector, but may be closer to an advertiser's point of presence in other sectors. As illustrated, the mobile terminal 16 is closer to advertiser point of presence A3 than advertiser point of presence A1; however, the location of the mobile terminal 16 in EAST2 limits receipt of advertisers from entities in WEST1, such as advertiser A3. Thus, the mobile terminal 16 will receive advertisements from advertiser A1 instead of the more proximate advertiser A3. Neither the user nor the advertiser can control the sector definitions or base content delivery on relative proximity. Accordingly, there is a need for a technique to provide location-based information to mobile terminals in a more effective and user-friendly manner.

### SUMMARY OF THE INVENTION

The present invention facilitates content delivery to a mobile terminal based on the proximity of the mobile terminal to a point of presence associated with a content provider. An application service may identify the location of the mobile terminal and use a locality database or service to determine localities containing the identified location. Based on the localities corresponding to the mobile terminal's location, content is selected and delivered to the mobile terminal. The localities may define any geographic region or area associated with a point of presence. For example, a locality may define a business district for a city, the city, or a defined area about a point of presence. For the latter, a locality could be defined to include an area having a certain radius about a retailer's point of presence or within a certain number of city blocks.

One or more profiles may be used to further filter the content delivered to the mobile terminal. Mobile terminal users may create profiles to identify the content or type of content to receive. The profiles may also define zones of acceptance that are static or move with the mobile terminal. Location information may be used to create a zone of acceptance according to profile criteria. The zone of acceptance may then be used to compare with defined localities. Similarly, service providers may create profiles identifying the type of users to receive select content. The service may use any relevant profiles in selecting appropriate content for delivery.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a representative map of typical location sectors defined according to the prior art.

FIG. 2 is a block representation of a communication environment according to one embodiment of the present invention.

FIG. 3 is a flow diagram outlining an exemplary application process according to one embodiment of the present invention.

FIGS. 4A through 4C are representative maps highlighting localities according to unique embodiments of the present invention.

FIGS. 5A through 5D are a communication flow diagram representing an exemplary operation according to one embodiment of the present invention.

FIG. 6 is a block representation of a mobile terminal constructed according to one embodiment of the present invention.

FIG. 7 is a block representation of an application server constructed according to one embodiment of the present invention.

FIG. 8 is a block representation of a locality server/database constructed according to one embodiment of the present invention.

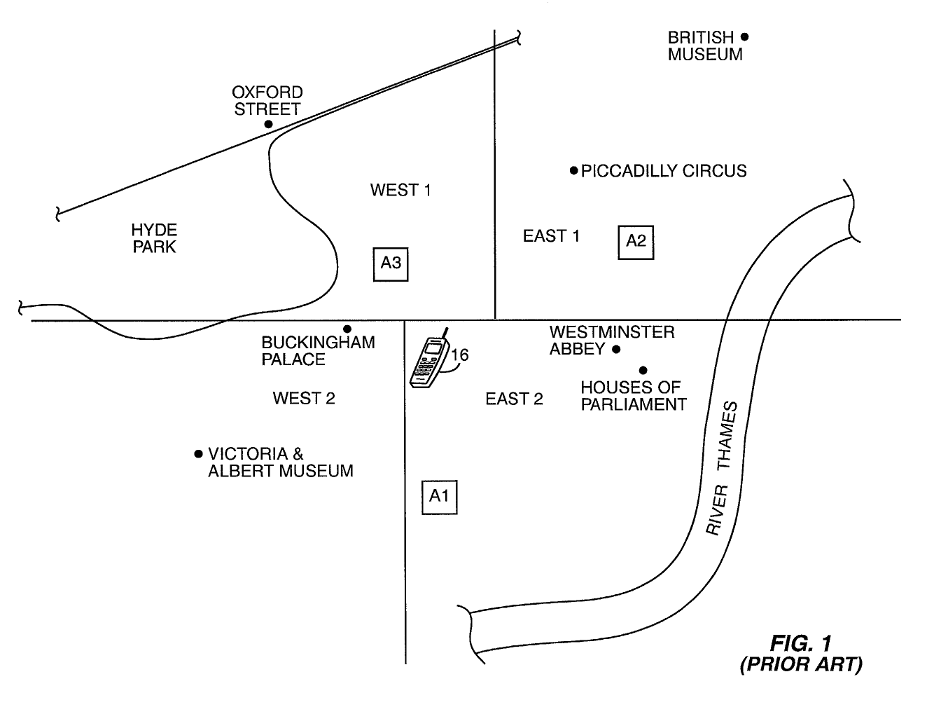

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

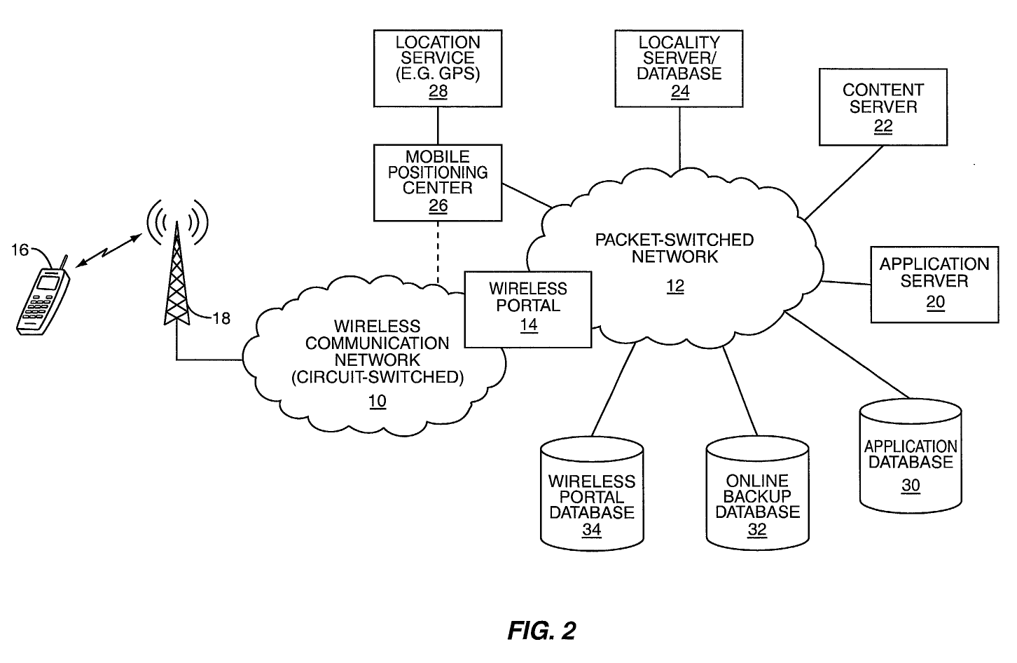

An exemplary communication environment is illustrated in FIG. 2. A wireless communication network 10 providing circuit-switched communications is configured to communication with devices on a packet-switched network 12 via a gateway, such as wireless portal 14. Those skilled in the art will recognize that the wireless communication network 10 may include or be associated with the public switched telephone network (PSTN) and packet switched networks 12 to facilitate call signaling, voice communications, and various types of messaging and information services.

In operation, a mobile terminal 16 will communicate with the wireless communication network 10 via a servicing base station 18. In addition to voice communications, various types of content may be provided to the mobile terminal 16 using short message service (SMS), wireless application protocol (WAP)/HTTP browser, email service, or other in-band communication function. Those skilled in the art will appreciate the various ways to deliver content to a mobile terminal 16.

In one embodiment, an application server 20 provides a content delivery service based on profiles created by the user of the mobile terminal 16, a content provider, or both. During operation, various types of information may be gathered from other services provided by a content server 22, locality server/database 24, or mobile positioning center 26. The content server 22 of the content provider may provide content for any type of information, such as advertisements, addresses, directions, marketing information, historical information, news, and the like.

The locality server/database 24 may provide a service to identify defined localities containing the current location for the mobile terminal 16. The location may be defined using latitudinal and longitudinal coordinates, which are associated with one or more localities containing the location by the locality server/database 24. The localities may define any geographic region or area associated with a point of presence. For example, a locality may define a business district for a city, the city, or a defined area about a point of presence. For the latter, a locality could be defined to include an area having a certain radius about a retailer's point of presence or within a certain number of city blocks in any number of directions.

The locality server/database 24 may also provide a service to expand the current location for the mobile terminal 16 into a zone of acceptance about the current location and identify localities overlapping the zone of acceptance. The zone of acceptance will move as the mobile terminal 16 moves and may change based on location or profile criteria. Further, the zone of acceptance may be configured to accept any localities having a portion within the zone of acceptance or may require the entire locality to fall within the zone of acceptance. Those skilled in the art will recognize there are an infinite number of ways to define and associate localities. Localities do not have to be associated with points of presence or content providers.

The mobile positioning center 26 represents any number of devices capable of determining or gathering location information for the mobile terminal 16 directly or indirectly though a location service 28, the wireless communication network 10, or the like. For example, if the mobile terminal 16 is equipped to determine and provide global positioning system (GPS) coordinates, the mobile positioning center 26 may access the GPS coordinates directly or through the location service 28. The wireless communication network 10 may also include equipment capable of providing enhanced observed time differentiation (E-OTD) or time distance of arrival (TDOA) techniques, which are capable of monitoring signals received from one or more base stations 18 to estimate the mobile terminal's 16 location. Those skilled in the art will recognize the available systems and techniques for approximating the mobile terminal's 16 actual position. These techniques may be provided by the wireless communication network 10 or independent systems.

The application server 20 may access other internal or external databases represented by the application database 30 and online backup database 32 to access profile and related application information as well as store content for future access by the application server 20. The wireless portal 14 may also have access to an internal or external database represented by wireless portal database 34. In operation, the wireless portal 14 may need to keep track of and authenticate communications between the mobile terminal 16 and elements on the packet-switched network 12.

In general, the application server 20 will determine the location of the mobile terminal 16, a locality or localities corresponding to the location, and whether to deliver content to the mobile terminal 16. In addition to location, content delivery may be based on profile criteria defining either the type of content to provide or a user type in which to deliver content via the mobile terminal 16.

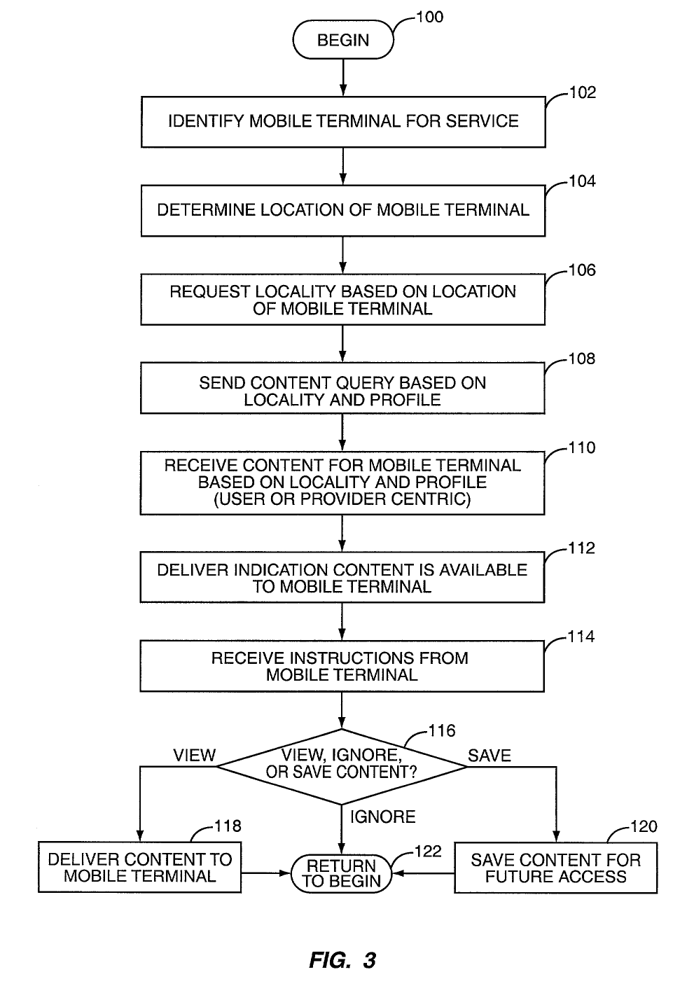

An exemplary process flow for one embodiment of the present invention is shown in FIG. 3. The process begins (step 100) by identifying an active mobile terminal 16 participating in the content delivery service (step 102). Next, the location of the mobile terminal 16 is determined (step 104). The application server 20 may access the location of the mobile terminal 16 from the mobile positioning center 26, which can determine the location of the mobile terminal from the wireless communication network 10 or independent location service 28. The location of the mobile terminal 16 may be determined from any capable service as well as from the mobile terminal 16 itself.

Upon accessing the mobile terminals 16 location, which is typically provided using coordinates such as latitude and longitude, the application server 20 will request a locality or group of localities corresponding to the mobile terminal's 16 location (step 106). For example, the latitude and longitude corresponding to the mobile terminal's 16 location provided by the mobile positioning center 26 is sent to the locality server/database 24 to identify localities encompassing the location. Please note that “encompass” is used to include locations within a locality as well as those within an acceptable proximity of the location, if so desired. The localities are returned to the application server 20, which will use the returned localities and profile information to create and send a query to the content server 22 identifying content to deliver to the mobile terminal 16 (step 108).

The content server 22 will process the query and return content matching the locality and profile criteria. The application server 20 will receive any content matching the locality and profile criteria (step 110) and notify the user that content is available by delivering a notification to the mobile terminal 16 indicating that content is available (step 112). The mobile terminal 16 may present the notification to the user and return a response from the user to the application server 20 indicating whether the user wants to view, ignore, or save the content (step 114). The application server 20 will take the appropriate action for the response (step 116) by delivering the content to the mobile terminal 18 (step 118), ignoring the content, or saving the content for future access and use (step 120). The process will then repeat (step 122).

As noted, profiles may be created for the mobile terminal 16 user and the point of presence (or content provider). With a user-based profile, the current location for a mobile terminal 16 may be converted into a zone of acceptance, which is compared with the localities defined in the locality server/database 24. Preferably, the zone of acceptance is determined based on location information using a spatial database implemented by the locality server/database 24, but those skilled in the art will recognize that other devices such as the application server 20 could perform such tasks. The zone of acceptance may be defined in a mobile terminal 16 user's profile and may be static or dynamic based on location. For example, the zone of acceptance may be configured to limit its scope if obstacles such as a body of water would render proximity information less meaningful.

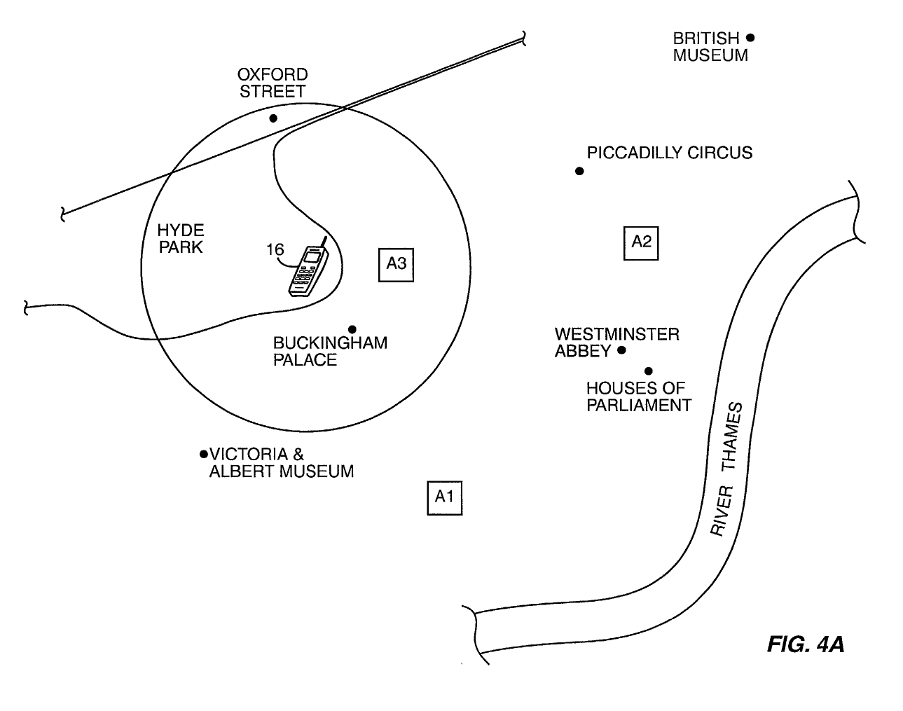

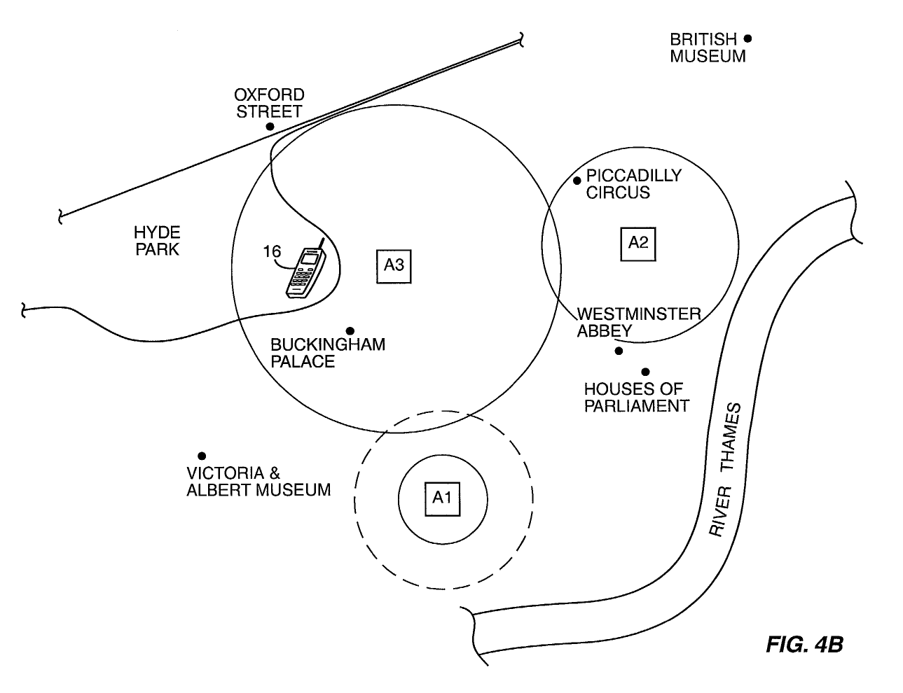

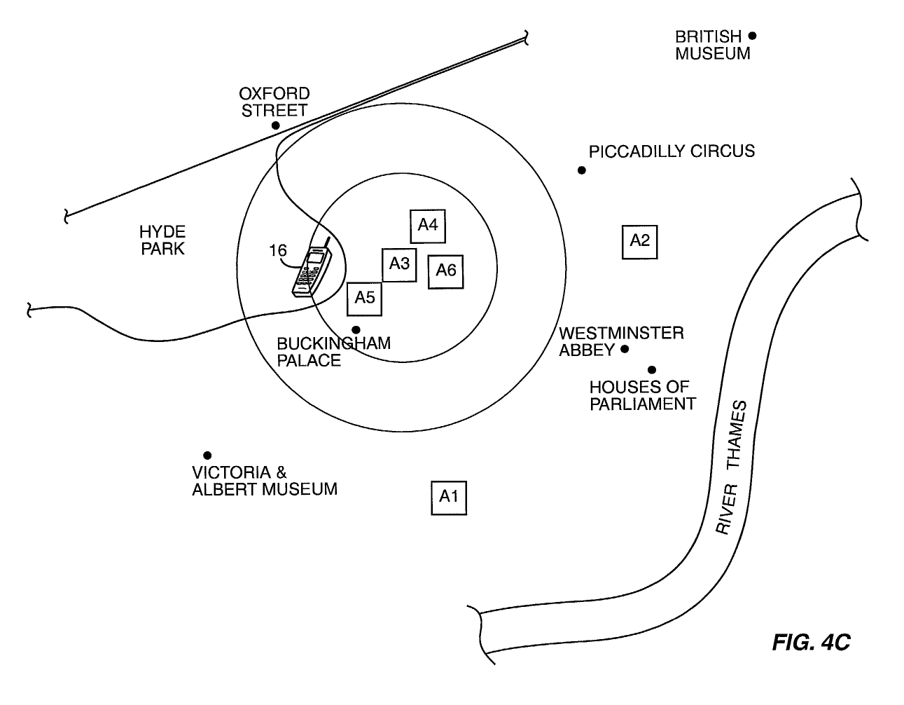

With reference to FIG. 4A, the circle about mobile terminal 16 represents a zone of acceptance defined by the mobile terminal 16 user in a user profile. The zone of acceptance is centered on the current position of the mobile terminal and includes an advertiser point of presence A3. The application server 20 will determine whether the advertiser point of presence A3 is in the zone of acceptance for the mobile terminal 16. The zone of acceptance may be defined as a circular boundary, but may be represented by any geometry, as well as one or more localities. As noted, a zone of acceptance may change as the user moves. Based on profile information, the locality server/database 24 may use the current location of the mobile terminal 16 to generate the zone of acceptance.

Alternatively, the profile may define one or more localities wherein the current location is used to identify corresponding localities, which are compared with localities defined in the profile. In this case, when the mobile terminal 16 is not within a user-defined locality, content is not provided. As such, zones of acceptance may correspond to localities that do not change with movement of the mobile terminal 16. When the mobile terminal 16 moves into the user-defined locality, content is provided.

Points of presence may define one or more associated localities. As shown in FIG. 4B, the point of presence for advertiser A1 is associated with concentric localities centered about the point of presence. The solid lined circle represents a first locality, and the dashed line circle represents the second locality. The smaller locality may be further associated with users having a casual desire for goods or services wherein the larger locality may be associated with users having a stronger desire for the goods or services. The latter group is potentially willing to travel further in response to advertising or marketing content.

Advertiser points of presence A2 and A3 have different sized, but overlapping localities. As such, advertiser A2 desires a smaller locality about its point of presence than advertiser A3. If each were advertising similar goods and services, a mobile terminal 16 located in the overlapping region of these localities could receive content from both advertisers A2 and A3. However, the user's profile may have a have a zone of acceptance limitation that would include advertiser A2, but not advertiser A3. Thus, the user profile may trump an advertiser's profile and vice versa.

Multiple content providers having approximately the same locations, such as retailers in a shopping mall or shopping district, may be associated with one another and provide common localities, and perhaps provide common content. As illustrated in FIG. 4C, advertiser points of presence A3 through A6 may be clustered together to form one or more localities. Profiles may associate larger localities with certain of the advertisers and smaller localities with other advertisers.

The application server 20 or the locality server/database 24 may be configured to expand localities or zones of acceptance, when no content is found for a mobile terminal's 16 current location or zone of acceptance, or when an insufficient number of mobile terminals 16 are found within a point of presence's locality. The application server 20 may request another layer of surrounding localities to expand the previously-determined area of interest for either the mobile terminal 16 or point of presence.

Notably, the localities may be used when recognizable geographic locations are deemed beneficial for content providers to define locations. Alternatively, the localities, as well as zones of acceptance, may be mathematically defined, such as a circular area having a radius of five miles and centered on a point of presence. Although circular localities are depicted, localities and zones of acceptance may take on any shape deemed appropriate for the content to deliver and the recipients thereof.

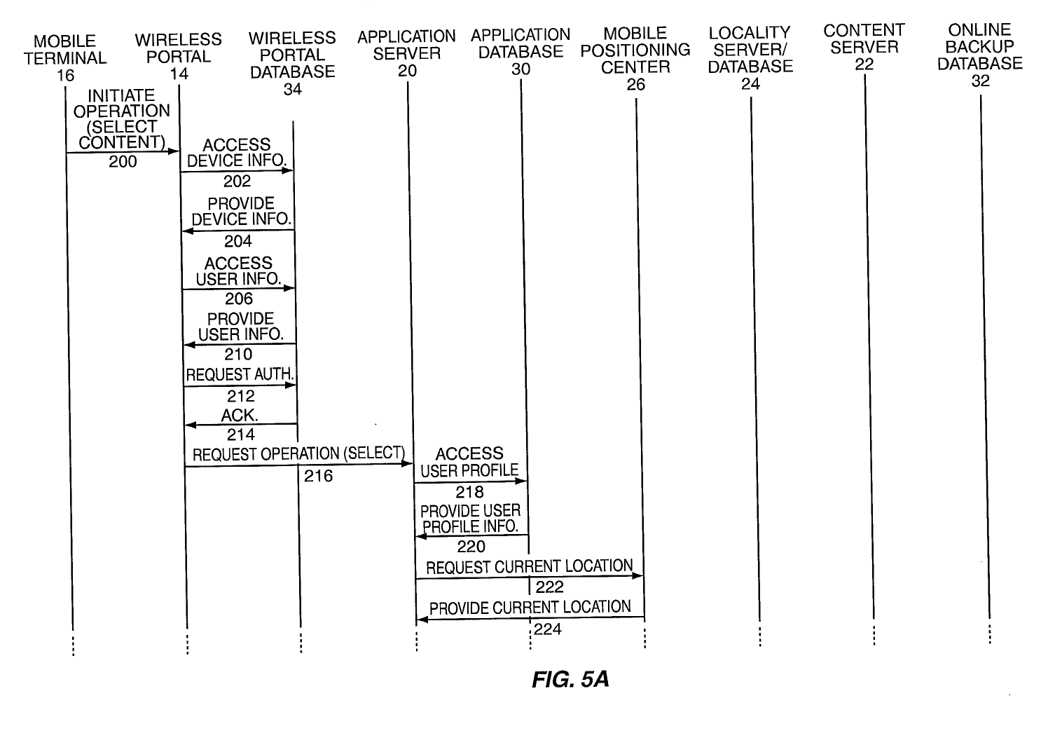

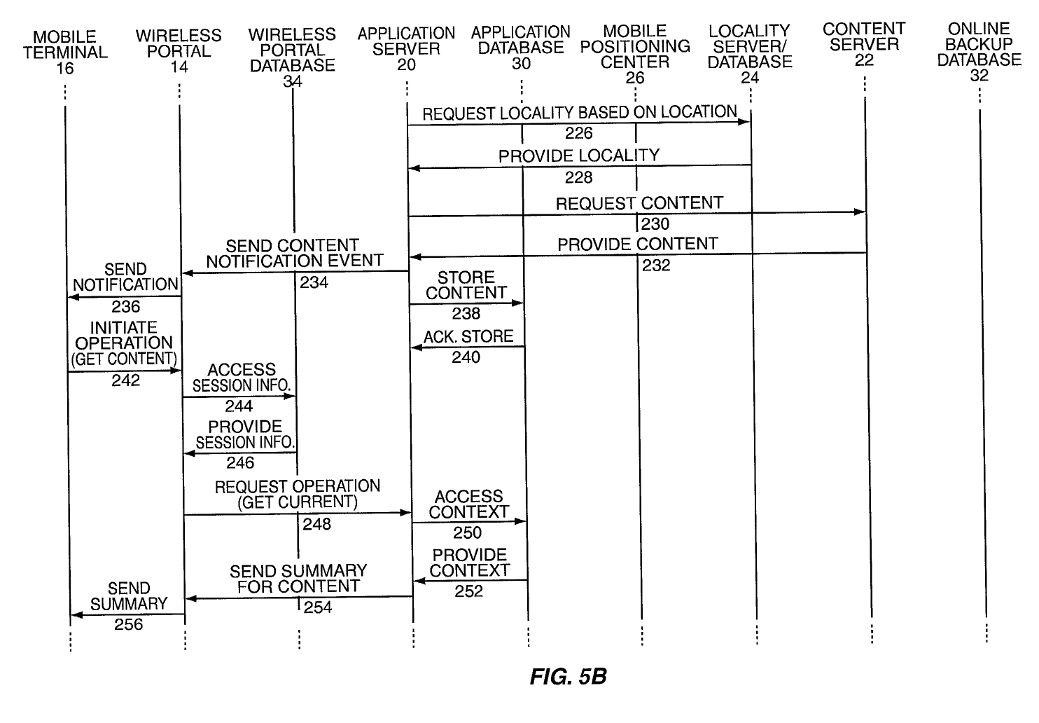

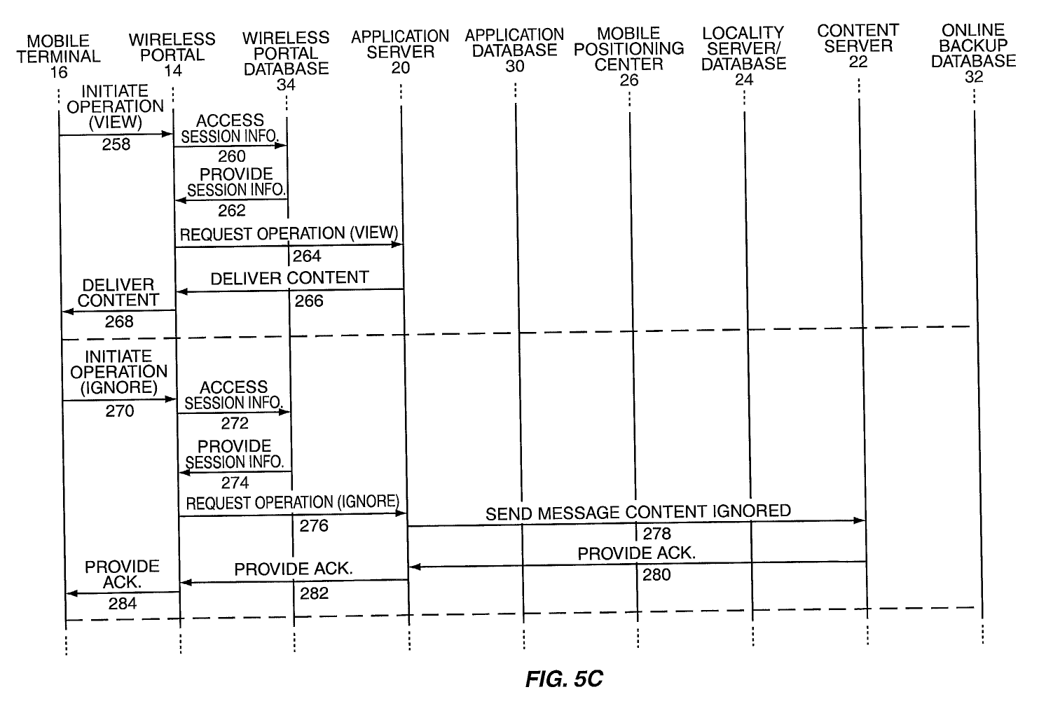

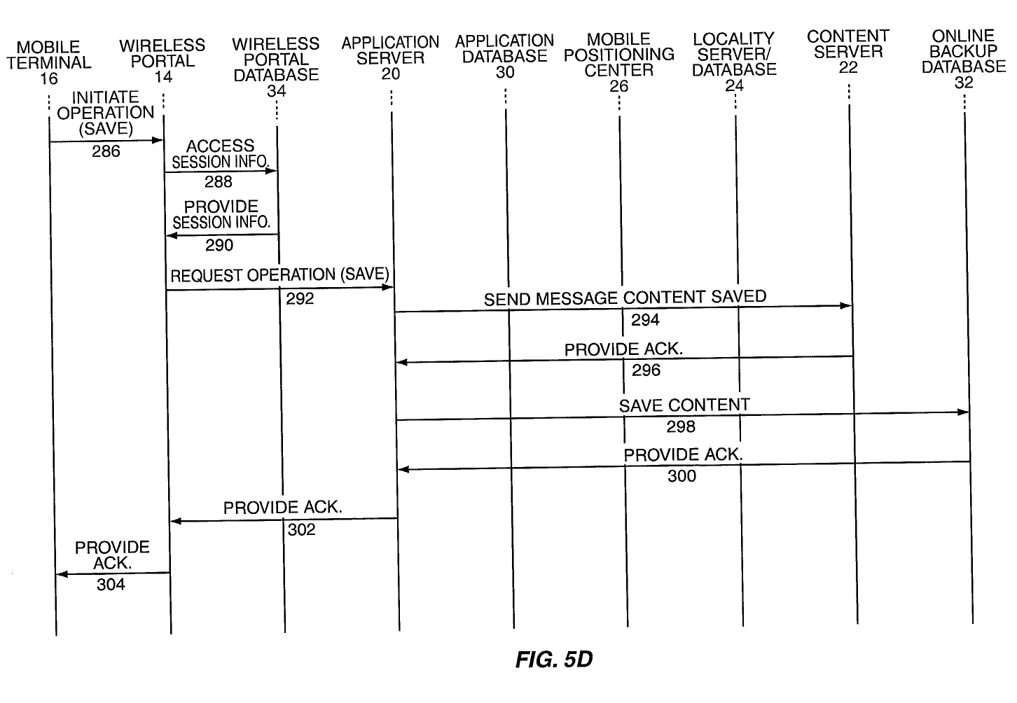

FIGS. 5A through 5D provide a representative communication flow for an exemplary embodiment of the present invention. Initially, the mobile terminal 16 may initiate operation by registering with the wireless portal 14 and initiating the services of the application server 20. In this embodiment, operation of the application server 20 is controlled based on instructions from the wireless portal 14 pertaining to functions triggered by the mobile terminal 16.

Initially, the application server 20 needs an “operation” request from the mobile terminal 16. As such, the mobile terminal 16 will initiate a “select content” operation by sending an appropriate message to the wireless portal 14 via the wireless communication network 10 (step 200). The wireless portal 14 will access the wireless portal database 34 using identification information received from the mobile terminal 16 to gather device information (steps 202 and 204). The device information may provide a device type, form factors for providing content, storage capability and the like. User identification may be provided based on the mobile terminal's 16 ID.

Next, user information may be gathered from the wireless portal database 34 pertaining to implementation of services, such as billing, levels of service, available services, and the like (steps 206 and 210). Finally, the wireless portal database 34 may be accessed to obtain authorization for the mobile terminal 16 to initiate the requested operation (steps 212 and 214).

After receiving authorization for the mobile terminal 16, the wireless portal 14 sends a request for the operation (“select content”) to the application server 20 on behalf of the mobile terminal 16 to initiate service or otherwise inform the application server 20 that the mobile terminal 16 is available (step 216). The application server 20 will then access the user's profile via the application database 30 (step 218), which will provide user profile information back to the application server 20 (step 220).

The application server 20 will next request current location information from the mobile positioning center 26 (or other location service) using the mobile terminal's 16 ID (step 222). The current location information is returned, typically using latitude and longitude coordinates, to the application server (step 224), which will request a locality list based on the returned location from the locality server/database 24 (step 226). The locality list for the location is returned and processed by the application server 20 based on any available user and content provider profiles (step 228).

A content request is created using relevant profile information and localities. The application server 20 will send the request for the content to the content server 22 (step 230), which will respond by providing the content to the application server 20 (step 232). Upon receipt of the content, the application server 20 will send a content notification event to the wireless portal 14 indicating content is available (step 234). The wireless portal 14 will send a corresponding notification to the mobile terminal 16 via the wireless communication network 10 (step 236). Concurrently, the application server 20 may temporarily store the content in the application database 30 (steps 238 and 240).

As described above, the mobile terminal 16 may respond by sending instructions to view, ignore or save the content for subsequent retrieval. To send a response to retrieve content, the mobile terminal 16 may initiate a corresponding operation by sending an operation (“get content”) to the wireless portal 14 (step 242), which will access information regarding the current session with the mobile terminal 16 (steps 244 and 246). After confirming authorization, the wireless portal 14 may send an operation (“get content”) request to the application server 20 (step 248), which will access the content to deliver the mobile terminal 16 from the application database 30 (steps 250 and 252).

The application server 20 may be configured to send a summary for the content to mobile terminal 16 via the wireless portal 14 in response to the operation (“get content”) (steps 254 and 256). The mobile terminal 16 will initiate another operation based on how the content should be processed. If the user elects to view the content, the mobile terminal 16 may initiate a corresponding operation by sending an operation (“view”) to the wireless portal 14 (step 258), which will access information regarding the current session with the mobile terminal 16 (steps 260 and 262). After confirming authorization, the wireless portal 14 may send an operation (“view”) request to the application server 20 (step 264), which will deliver the content to the mobile terminal 16 via the wireless portal 14 (steps 266 and 268).

If the user elected to ignore the content, the mobile terminal 16 may initiate a corresponding operation by sending an operation (“ignore”) to the wireless portal 14 (step 270), which will access information regarding the current session with the mobile terminal 16 (steps 272 and 274). After confirming authorization, the wireless portal 14 may send an operation (“ignore”) request to the application server 20 (step 276), which may send a corresponding message to the content server 22 (step 278). The content server 22 may process the information indicating the content was ignored and acknowledge receipt of the message (step 280). The application server 20 may send a corresponding acknowledgment to the mobile terminal 16 via the wireless portal 14 (steps 282 and 284).

If the user elected to save the content, the mobile terminal 16 may initiate a corresponding operation by sending an operation (“save”) to the wireless portal 14 (step 286), which will access information regarding the current session with the mobile terminal 16 (steps 288 and 290). After confirming authorization, the wireless portal 14 may send an operation (“save”) request to the application server 20 (step 292), which may send a corresponding message to the content server 22 (step 294). The content server 22 may process the information indicating the content was saved and acknowledge receipt of the message (step 296). The application server 20 may then send the content to be stored on the online backup database 32 (step 298), which will respond with an acknowledgment (step 300). The application server 20 may send a corresponding acknowledgment to the mobile terminal 16 via the wireless portal 14 (steps 302 and 304).

The above example illustrates a request for content originating from the mobile terminal 16. Requests for content may be originated in a number ways, including letting the user initiate request for content based on code or instructions residing on the mobile terminal 16 or provided to the mobile terminal from the application server 20. For example, the application server 20 may provide interactive menus for the mobile terminal 16 to display to the user to facilitate interaction and content requests. Alternatively, code or instructions originally resident on the mobile terminal 16 or provided by the application server 20 may be configured to automatically request content on a periodic basis or upon the occurrence of any defined event, such as entering a new cell or receiving, initiating or ending a call.

Content requests may also be generated independent of the mobile terminal. For example, the requests may be triggered by a daemon running on the application server 20, which monitors users participating in the content service and the location of the users' mobile terminals 16. The daemon will trigger a request for content based on location and in light of any defined profiles. As an example, the daemon may poll mobile terminal locations for all participating users via the mobile positioning server 26. As such, the daemon's poll algorithm would replace the above steps 200-240 wherein steps 200-214 would not be necessary since the daemon runs on the application server and requires no authentication. Step 236 (send notification) could be an SMS message to the user indicating content is available, and the user would, at some subsequent time, retrieve the content starting with step 242.

The polling algorithm for the daemon would essentially identify location-based information for the mobile terminal 16 and trigger content according to any number of scenarios. For example, the polling algorithm may identify changes in location or remaining in one location for a long time, which could be defined by service-level profiles such as ten poll times or a defined period of time. The polling algorithm could also detect direction and relative or current velocity to help determine when and if to provide content.

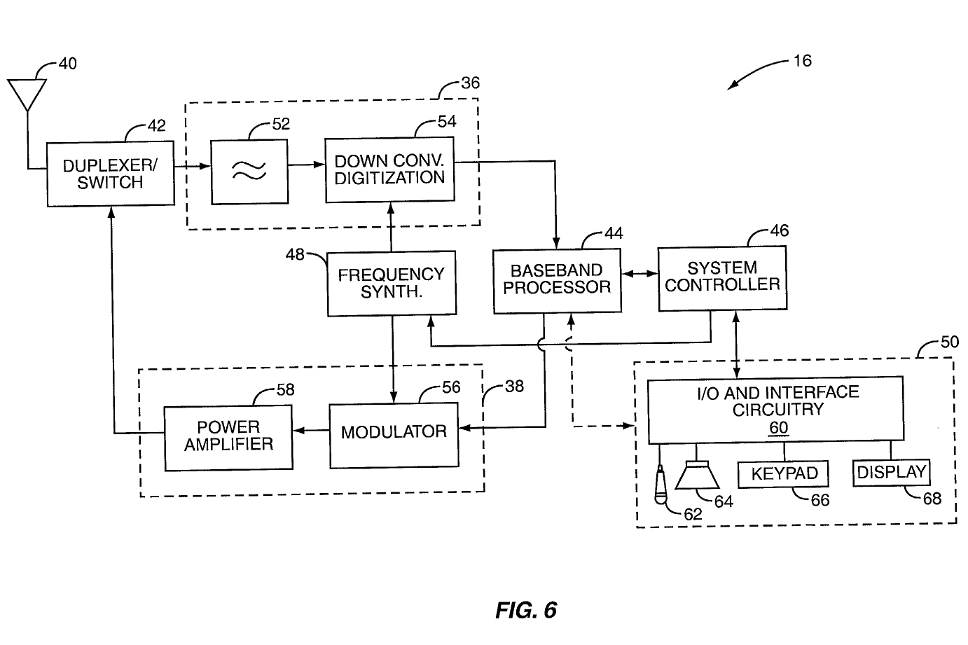

The location monitoring of the server application 20 may be combined with or work in association with the requests initiated by the user or by the mobile terminal 16 itself. As such, users can elect when and if they want the system to track their locations and still access content as desired regardless of tracking. Those skilled in the art will recognize numerous variants on these themes that are considered within the scope of this disclosure. Although the mobile terminal 16 may take on many configurations, an exemplary mobile terminal 16 is represented in FIG. 6. The mobile terminal 16 may include a receiver front end 36, a radio frequency transmitter section 38, an antenna 40, a duplexer or switch 42, a baseband processor 44, a system controller 46, a frequency synthesizer 48, and an interface 50. The receiver front end 36 receives information bearing radio frequency signals from one or more remote transmitters provided by the base station 14. A filter circuit 52 minimizes broadband interference in the received signal, while a downconverter 54 downconverts the filtered, received signal to an intermediate or baseband frequency signal, which is then digitized into one or more digital streams. The receiver front end 36 typically uses one or more mixing frequencies generated by the frequency synthesizer 48.

The baseband processor 44 processes the digitized received signal to extract the information or data bits conveyed in the received signal. This processing typically comprises demodulation, decoding, and error correction operations. As such, the baseband processor 44 is generally implemented in one or more digital signal processors (DSPs).

On the transmit side, the baseband processor 44 receives digitized data from the system controller 46, which it encodes for transmission. The encoded data is output to the transmitter 38, where it is used by a modulator 56 to modulate a carrier signal that is at a desired transmit frequency. A power amplifier 58 amplifies the modulated carrier signal to a level appropriate for transmission from the antenna 40.

A user may interact with the mobile terminal 16 via the interface 50, which may include input/output (I/O) and interface circuitry 60 associated with a microphone 62, a speaker 64, a keypad 66, and a display 68. The I/O and interface circuitry 60 typically includes analog-to-digital converters, digital-to-analog converters, amplifiers, and the like. Additionally, it may include a voice encoder/decoder, in which case it may communicate directly with the baseband processor 44.

The microphone 62 will typically convert audio input, such as the user's voice, into an electrical signal, which is then digitized and passed directly or indirectly to the baseband processor 44. Audio information encoded in the received signal is recovered by the baseband processor 44, and converted into an analog signal suitable for driving speaker 64 via the I/O and interface circuitry 60. The keypad 66 and display 68 enable the user to interact with the mobile terminal 16, for example input numbers to be dialed, address book information, or the like, as well as monitor call progress information.

Particularly useful for the present invention, the display 68 may be used for more data-intensive applications, such as providing messages and information using the short messaging service (SMS), paging, email, and the like. Messages may be sent to the mobile terminal 16 to indicate that content is available for viewing, describe available content, or provide any information related to accessing, providing, and displaying content according to the present invention.

In one embodiment, the display 68 and keypad 66 cooperate to provide soft-key functions wherein icons displayed on the display 68 are presented to the user and may be selected upon pressing an associated key. The icons may represent available content and trigger display of the content when pressed. Additionally, icons may be provided to give the user options to request, view, ignore, and save content.

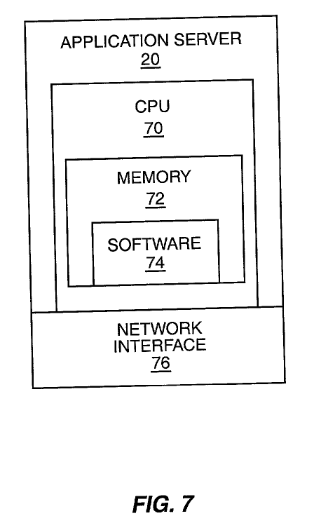

As shown in FIG. 7, the application server 20 may be a typical web server having a central processing unit (CPU) 70 with the requisite memory 72 containing the software 74 and data necessary for operation. The CPU 70 is associated with a network interface 76 facilitating communications with other devices, such as the wireless portal 14, mobile positioning center 26, content server 22, online backup database 32, locality server/database 24, wireless portal database 34, and application database 30, on the packet-switched network 12 through any number of local area networks, routers, switches and hubs in traditional fashion.

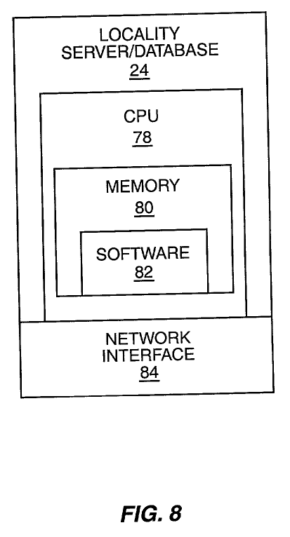

As shown in FIG. 8, the locality server/database 24 may be a typical web server having a central processing unit CPU 78 with the requisite memory 80 containing the software 82 and data necessary for operation. The CPU 78 will preferably implement a spatial database capable of providing the operation described above. The CPU 78 is also associated with a network interface 84 facilitating communications with other devices, such as the application server 20, mobile positioning center 26, content server 22, online backup database 32, locality server/database 24, wireless portal database 34, and application database 30, on the packet-switched network 12 through any number of local area networks, routers, switches and hubs in traditional fashion.

Those skilled in the art will recognize improvements and modifications to the preferred embodiments of the present invention. All such improvements and modifications are considered within the scope of the concepts disclosed herein and the claims that follow.

What is claimed is:

1. A method for delivering content to a mobile terminal comprising:
a) determining a location of the mobile terminal;
b) determining a locality encompassing the location of the mobile terminal;
c) accessing content based on the locality; and
d) delivering the content to the mobile terminal.

2. The method of claim 1 wherein the locality encompassing the mobile terminal is determined by:
a) sending a request to a locality service to associate the location of the mobile terminal with a locality encompassing the location of the mobile terminal;
b) receiving a response from the locality service identifying the locality encompassing the location of the mobile terminal; and
c) wherein the locality service includes a plurality of locations defining geographic areas.

3. The method of claim 1 wherein the content is accessed by:
a) sending a request to a content provider including the locality; and
b) receiving the content from the content provider.

4. The method of claim 1 wherein the step of accessing content is further based on a type of content desired by a user of the mobile terminal.

5. The method of claim 1 wherein the step of accessing content is further based on characteristics of a user of the mobile terminal.

6. The method of claim 1 wherein the locality defines a recognized geographic area.

7. The method of claim 1 wherein the locality defines a geographic area about a point of presence for a content provider.

8. The method of claim 1 wherein the content accessed based on locality relates to a point of presence within the locality.

9. The method of claim 1 further comprising accessing a profile associated with a user of the mobile terminal and wherein the step of accessing the content is further based on criteria within the profile such that the criteria further identifies the type of content to access.

10. The method of claim 1 further comprising accessing a profile associated with a point of presence with the locality and wherein the step of accessing the content is further based on criteria within the profile such that the criteria further identifies the type of content to access.

11. The method of claim 1 wherein the locality encompassing the mobile terminal is determined by identifying a zone of acceptance about the location of the mobile terminal and identifying the locality at least partially covering the zone of acceptance.

12. A system for delivering content to a mobile terminal comprising an interface and a control system adapted to:
a) determine a location of the mobile terminal;
b) determine a locality encompassing the location of the mobile terminal;
c) access content based on the locality; and
d) send the content to the mobile terminal.

13. The system of claim 12 wherein the control system is further adapted to determine the locality encompassing the mobile terminal by:
a) sending a request to a locality service to associate the location of the mobile terminal with a locality encompassing the location of the mobile terminal;
b) receiving a response from the locality service identifying the locality encompassing the location of the mobile terminal; and
c) wherein the locality service includes a plurality of locations defining geographic areas.

14. The system of claim 12 wherein the control system is further adapted to access the content by:
a) sending a request to a content provider including the locality; and
b) receiving the content from the content provider.

15. The system of claim 12 wherein the control system is further adapted to access the content based on a type of content desired by a user of the mobile terminal.

16. The system of claim 12 wherein the control system is further adapted to access the content based on characteristics of a user of the mobile terminal.

17. The system of claim 12 wherein the locality defines a recognized geographic area.

18. The system of claim 12 wherein the locality defines a geographic area about a point of presence for a content provider.

19. The system of claim 12 wherein the content accessed based on locality relates to a point of presence within the locality.

20. The system of claim 12 wherein the control system is further adapted to access a profile associated with a user of the mobile terminal and access the content based on criteria within the profile such that the criteria further identifies the type of content to access.

21. The system of claim 12 wherein the control system is further adapted to access a profile associated with a point of presence with the locality and to access the content based on criteria within the profile such that the criteria further identifies the type of content to access.

22. The system of claim 12 wherein the locality encompassing the mobile terminal is determined by identifying a zone of acceptance about the location of the mobile terminal and identifying the locality at least partially covering the zone of acceptance.

23. A computer-readable medium with software comprising instructions for a computer to:
a) determine a location of a mobile terminal;
b) determine a locality encompassing the location of the mobile terminal;
c) access content based on the locality; and
d) send the content to the mobile terminal.

24. A method for delivering content to a mobile terminal comprising:
a) determining a location of the mobile terminal;
b) determining a location of a point of presence having associated content;
c) determining a relative proximity between the location of the mobile terminal and the location of the point of presence;
d) accessing the associated content if the relative proximity between the location of the mobile terminal and the location of the point of presence is within a desired range; and
e) delivering the associated content to the mobile terminal.

25. The method of claim 24 wherein the location of the point of presence is a locality.

26. The method of claim 25 wherein the relative proximity between the location of the mobile terminal and the location of the point of presence is determined by determining a locality encompassing the location of the mobile terminal.
